(19) United States
(12) Patent Application Publication
(10) Pub. No.: US 2024/0263071 A1
(43) Pub. Date: Aug. 8, 2024

(54) INFRARED-EXCITED INFRARED LUMINESCENT MATERIAL, PREPARATION METHOD THEREOF, SECURITY ARTICLES FOR ANTI-COUNTERFEIT

(71) Applicant: NANO CMS CO., LTD., Seobuk-gu, Cheonan-si Chungcheongnam- do (KR)

(72) Inventors: Sang Geun Lee, Yuseong-gu, Daejeon (KR); Shi Surk Kim, Dongnam-gu,Cheonan-si, Chungcheongnam-do (KR); Si Bo Kim, Seobuk-gu, Cheonan-si, Chungcheongnam-do (KR); Woo Sung Lim, Seobuk-gu, Cheonan-si, Chungcheongnam-do (KR)

(73) Assignee: NANO CMS CO., LTD., Seobuk-gu, Cheonan-si Chungcheongnam- do (KR)

(21) Appl. No.: 18/565,367

(22) PCT Filed: Oct. 28, 2021
(86) PCT No.: PCT/KR2021/015358

§ 371 Date: Nov. 29, 2023

(30) Foreign Application Priority Data
Jun. 1, 2021 (KR) 10-2021-0070813

(51) Int. Cl. C09K 11/77; B42D 25/382; C09D 11/037; C09D 11/50

(52) U.S. Cl. CPC C09K 11/7776; B42D 25/382; C09D 11/037; C09D 11/50; C09K 11/7774; C09K 11/77742

(57) ABSTRACT

An infrared-excited infrared light emitting material and a preparation method thereof, and a security article for anti-counterfeit using thereof relate to a white to pale colored infrared-excited infrared light emitting material, a preparation method thereof, and an ink composition for anti-counterfeit containing the infrared exciting infrared light emitting material which visually appears white or colored, and is excited in the infrared region, emits light in the infrared region, but does not emit light in the visible region, and a security article requiring confirmation of authenticity and anti-counterfeit.

### TECHNICAL FIELD

The present invention relates to an infrared-excited infrared light emitting material and a preparation method thereof, and a security article for anti-counterfeit using thereof, and more specifically, relates to a white to pale colored infrared-excited infrared light emitting material, a preparation method thereof, and an ink composition and security articles for anti-counterfeit using thereof that have characteristics such that it is excited when it receives a light with a wavelength in the range of 800˜1000 nm, which is an infrared region, the excited energy induces light emitting in the range of 1000˜1700 nm, which is an infrared region, but does not emit light in the wavelength range of 380˜780 nm, which is a visible region.

### BACKGROUND ART

In general, inks are manufactured using fatty acid-modified resins, alkyd resins, rosin-modified resins, petroleum resins, urethane resins, epoxy resins, and the like; sheets are manufactured using pulp, fibers, plastics, and the like; and when manufacturing inks and sheets, inorganic fillers are used to improve whiteness, increase opacity, improve printability, reduce costs, and the like.

Inorganic fillers include clay, kaolin, calcium carbonate, titanium dioxide, white carbon, and the like, but these fillers added in the manufacturing process of inks and sheets do not have any function other than the effects of improving whiteness, increasing opacity, improving printability, reducing costs, and the like.

However, since inks and sheets with anti-counterfeit function require special functions such as anti-counterfeit, authenticity identification and device detection, the anti-counterfeit function can be strengthened by using a material that absorbs energy in a range of electromagnetic waves that is white to pale color, or emits light by using it as excitation light.

Among materials that absorb energy in various electromagnetic wave regions or emit light by using it as excitation light, requiring special functions such as anti-counterfeit, authenticity identification and device detection, and white to pale in color, mostly inorganic types are used since the organic types have weak resistance in general, however, the inorganic types have strong resistance, but the luminous intensity is weaker than that of the organic type, and in addition, as the atomization is increased, the luminous intensity is significantly lowered, which has a constraint that has no choice but to increase the amount of use.

Meanwhile, looking at an example of the prior art related to the infrared light emitting body, Patent Application Nos. 1020100009573, 1020090028449, 1020060135194, 1020100135899, and the like are disclosed, but it relates to an infrared light emitting fluorescent body using ultraviolet or visible light as an excitation wavelength, and when the excitation wavelength is visible light, it has an absorption wavelength depending on the color, so it is subject to color restrictions.

Accordingly, the present inventors completed the present invention by increasing the ease of manufacturing security products such as ink, sheet, film, yarn, and container by reducing the amount of use by providing a white to pale colored infrared-excited infrared light emitting material that has significantly high luminance even with small particles and enables to be mixedly used between luminescent materials, and by confirming that security articles for anti-counterfeit that uses infrared-excited infrared light emitting material not affected by colors except carbon black by emitting infrared rays through excitation of infrared rays can be manufactured.

### PRIOR ART LITERATURE

### Patent Literature

Korea Registered Patent No. 0959362 (published on May 20, 2010)

### DISCLOSURE

### Technical Problem

Therefore, the object of the present invention is to provide a white to pale colored infrared-excited infrared light emitting material and a preparation method thereof that have characteristics such that it is excited when it receives a light with a wavelength in the range of 800˜1000 nm, which is an infrared region, the excited energy induces light emitting in the range of 1000˜1700 nm, which is an infrared region, but does not emit light in the wavelength range of 380˜780 nm, which is a visible region.

Another object of the present invention is to increase the ease of manufacturing security products such as ink, sheet, film, yarn, container, and the like, and enable to be mixedly used between luminescent materials by providing a white to pale colored infrared-excited infrared light emitting material that has significantly high luminance even with small particles.

Another object of the present invention is to provide an ink composition for anticounterfeit containing the white to pale colored infrared-excited infrared light emitting material, which visually appears white or colored, but has a characteristic of being excited in the infrared region and emitting light in the infrared region, but does not emit light in the visible region, and security articles such as printed materials, sheets, films, yarns, containers, and the like that require verification of authenticity and anticounterfeit.

### Solution to Problem

In order to achieve the above object, the present invention provides a white to pale colored infrared-excited infrared light emitting material that have characteristics such that it is excited when it receives a light with a wavelength in the range of 800˜1000 nm, which is an infrared region, the excited energy induces light emitting in the range of 1000˜1700 nm, which is an infrared region, but does not emit light in the wavelength range of 380˜780 nm, which is a visible region.

In an infrared-excited infrared light emitting material according to the present invention is characterized in that the luminescent material is a single light emitting body selected from compounds represented by Chemical Formula 1 or Chemical Formula 2 below alone or a mixture thereof.

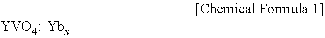

Here, 0<x≤1.

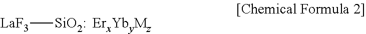

Here, M is Zn, Mg, and Ce, and 0<x≤1, 0<y≤1, 0<z≤1.

The present invention also provides a preparation method for an infrared-excited infrared light emitting material characterized by comprising the steps of: a) mixing at least one of lanthanide metal oxides or metal salts selected from the group consisting of compounds containing lanthanum salts, silica salts, erbium salts and ytterbium salts or compounds containing lanthanum fluoride, silicon dioxide, ytterbium oxide and erbium oxide, and zinc, magnesium and cesium; b) heat-treating the mixture obtained in step a) to prepare a luminescent powder of Chemical Formula 2; and c) controlling the particle size of the luminescent powder.

In a method for preparing an infrared-excited infrared light emitting material according to the present invention, above step b) is characterized by heat-treating the mixture obtained in step a) at a temperature between 800° C. to 1300° C. to prepare a luminescent powder of Chemical Formula 2.

The present invention also provides an ink composition for anti-counterfeit that includes an infrared-excited infrared light emitting material having an external color of white to pale color and emitting infrared light when excited by infrared light, and emitting one or two infrared wavelengths at the same infrared excitation wavelength, but not emitting light in the visible region.

In an ink composition for anti-counterfeit according to the present invention, it has characteristics in that the infrared-excited infrared light emitting material that has an external color of white to pale color and emits infrared light when excited by infrared light is either alone or a mixture selected from Chemical Formula 1 or Chemical Formula 2, and visually appears to be white to colored, and excited by infrared ray when it receives a light with a wavelength in the range of 800˜1000 nm, which is an infrared region, the excited energy induces light emitting in the range of 1000˜1700 nm, which is an infrared region, but does not emit light in the wavelength range of 380˜780 nm, which is a visible region.

The ink composition for anti-counterfeit according to the present invention is characterized in that it is one selected from the group consisting of screen printing, lithographic printing, gravure printing, intaglio printing, letterpress printing, flexographic printing, and inkjet ink.

The present invention also provides an article for anti-counterfeit including an infrared-excited infrared light emitting material having an external color of white to pale color emitting infrared light when excited by infrared light, emitting one or two infrared wavelengths at the same infrared excitation wavelength, but not emitting light in the visible region.

In an article for anti-counterfeit according to the present invention, it has characteristics in that the infrared-excited infrared light emitting material having an external color of white to pale and emitting infrared light when excited by infrared light is selected from Chemical Formula 1 or Chemical Formula 2 alone or a mixture thereof, and visually appear white or colored, and it is excited when it receives a light with a wavelength in the range of 800˜1000 nm, which is an infrared region, the excited energy induces light emitting in the range of 1000˜1700 nm, which is an infrared region, but does not emit light in the wavelength range of 380˜780 nm, which is a visible region.

In an article for anti-counterfeit according to the present invention, it is characterized in that the article is a printed matter, a sheet, a film, a yarn or a container.

In an article for anti-counterfeit according to the present invention, it is characterized in that the material of the printed material, sheet and film is one selected from paper material, fiber material and plastic material; and the material of the yarn and the container are characterized in that it is one selected from polyester resin, polyethylene resin, polypropylene resin, polycarbonate resin, polyvinyl chloride, polyamide resin, polyurethane, and polyethylene terephthalate (PET).

In an article for anti-counterfeit according to the present invention, it is characterized in that it contains 0.01˜50 w % of the infrared-excited infrared light emitting material.

In an article for anti-counterfeit according to the present invention, it is characterized in that the article is selected from the infrared-excited infrared light emitting material of Chemical Formula 1 or Chemical Formula 2, alone or a mixture thereof is completely or partially distributed.

### Advantageous Effects of Invention

Since an invisible light emitting body manufactured according to the present invention has a significantly higher luminous intensity than the conventional light emitting body even at a small particle size, it can be applied to ink composition, printed matter, sheet, film, yarn, and container, and can be used by mixing a light emitting body.

In addition, since the invisible light emitting body of the present invention is excited by light in the infrared region to emit light in the infrared region, a commercially available infrared LED or infrared LD can be used as a light source, by using an in-gas detector for detection, it cannot be visually determined, but it can be determined by a device, so it can be used for security articles that need to check authenticity and anticounterfeit.

In addition, since the excitation wavelength is infrared, there is no color interference, and there is no upward transition by using erbium and ytterbium, and it emits only infrared light when excited by infrared light, so that it is possible to manufacture ink compositions, prints, sheets, films, yarns and containers with better security.

### BRIEF DESCRIPTION OF DRAWINGS

FIG. 1 is an emission wavelength spectrum obtained by Application Example 1 according to the present invention.

FIG. 2 is a photograph of a detector prepared to detect near-infrared light emission of an application example according to the present invention.

### BEST MODE FOR CARRYING OUT THE INVENTION

Since the present invention can apply various transformations and can have various embodiments, preferred embodiments will be described in detail. It will be apparent to those skilled in the art that the present invention may be embodied in other specific forms without departing from the spirit and essential characteristics of the present invention.

Unless otherwise defined, all technical and chemical terms used herein have the same meaning as commonly understood by one of ordinary skill in the art to which this invention belongs. In general, the nomenclature used herein and the experimental methods described below are well known and commonly used in the art.

Hereinafter, the present invention will be described in detail with reference to the accompanying drawings.

The present invention provides a white to pale colored infrared-excited infrared light emitting material represented by Chemical Formula 1 and Chemical Formula 2 below.

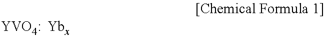

Here, 0<x≤1.

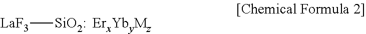

Here, M is Zn, Mg, and Ce, and 0<x≤1, 0<y≤1, 0<z≤1.

The infrared-excited infrared light emitting material of Chemical Formula 1 is provided according to the applicants' company patent WO202000153762A1, and the infrared-excited infrared light emitting material of Chemical Formula 2 is provided through the steps of a) mixing at least one lanthanide metal oxides or metal salts selected from the group consisting of compounds containing lanthanum salts, silica salts, erbium salts and ytterbium salts, or materials containing lanthanum fluoride, silicon dioxide, ytterbium oxide, and erbium oxide, and zinc, magnesium and cesium; b) preparing a luminescent powder by heating up the temperature of the mixture obtained in step a) and heat-treating at a temperature between 800˜1300° C.; and c) controlling the particle size of the luminescent powder, wherein the particle size corresponding to 90% of the maximum particle size in the cumulative particle size distribution is preferably 0.01˜50 μm, and more preferably 0.1˜10 μm.

The compounds of Chemical Formula 1 and the compounds of Chemical Formula 2 are characterized in that they are excited when it receives a light with a wavelength in the range of 800˜1000 nm, which is an infrared region, the excited energy induces light emitting in the range of 1000˜1700 nm, which is an infrared region, but does not emit light in the wavelength range of 380˜780 nm, which is a visible region.

The security articles of the present invention such as ink composition for anticounterfeit and printed materials, sheets, films, yarns and containers are characterized in that they include the compounds of Chemical Formula 1 and the compounds of Chemical Formula 2 alone or a mixture thereof.

The security article is characterized in that they are a printed product, sheet, film, yarn, and container selected from the infrared excitation infrared luminescent material of Chemical Formula 1 or Chemical Formula 2 and in which alone or a mixture thereof is fully or partially distributed.

That is, the present invention prepares compounds consisting of yttrium vanadate compounds and ytterbium of Chemical Formula 1, lanthanum prolide-silica compounds of Chemical Formula 2, and compounds consisting of erbium, ytterbium, zinc, magnesium, and cesium, and, by using this, provides ink composition alone or a mixture thereof having infrared-excited infrared emitting characteristic and security articles such as printed matter, sheet, film, yarn, container, and the like having the above characteristics.

Therefore, ink composition, printed matter, sheet, film, yarn and container for authenticity and anti-counterfeit of the present invention, include the compounds of Chemical Formula 1 or the compounds of Chemical Formula 2, which are white to pale colored infrared-excited infrared light emitting materials alone or in admixture, so that visually, it appears white or colored but has a characteristics of being excited by infrared rays to emit infrared rays but not emitting visible light.

In addition, since the excitation wavelength is infrared, it is possible to colorize it by mixing most of the colored pigments that do not absorb infrared, and by overcoming the luminous intensity and particle size of the existing inorganic light emitting body, it has luminous intensity and particle size that can identify authenticity and prevent counterfeit even compounds composed of yttrium vanadate compounds and ytterbium and compounds composed of lanthanum prolide-silica compounds and erbium and ytterbium are mixedly used.

It is characterized in that the ink composition for anti-counterfeit is one selected from the group consisting of screen printing ink, lithographic ink, gravure printing ink, intaglio printing ink, letterpress printing ink, flexographic printing ink, and inkjet ink.

In addition, the material of the anti-counterfeit print, sheet and film is characterized in that it is one selected from paper material, fiber material, and plastic material, and the material of the anti-counterfeit yarn and container is characterized in that it is one selected from polyester resin, polyethylene resin, polypropylene resin, polycarbonate resin, polyvinyl chloride, polyamide resin and other polymer compounds.

In addition, the anti-counterfeit ink composition, printed matter, sheet, film, yarn and container of the present invention may contain 0.01˜50 w % of the light emitting body of Chemical Formula 1 or Chemical Formula 2 alone or a mixture thereof, based on the total weight.

Hereinafter, the present invention will be described in more detail through Embodiments and Experimental Examples, but the following Embodiments and Experimental Examples are for illustrative purposes only, and are not intended to limit the scope of the present invention.

### <Embodiment 1>Preparation of a Compound Consisting of an Yttrium Vanadate Compound and Ytterbium

1) Each of the raw materials used in Table 1 is mixed according to the weight ratio and homogenized.

TABLE 1

| Material Name | Molecular Weight | Embodiment 1 |
|---|---|---|
| Yb₂O₃ | 394.08 | 32 w % |
| Y₂O₃ | 225.84 | 28 w % |
| NH₄VO₃ | 116.98 | 40 w % |

Hereinafter, the light emitting body of the present invention was manufactured according to the following steps.
2) The homogenized powder of 1) is mixed in a four-mouth flask containing a mixed solution of 300 ml of ethanol and 400 ml of water, and homogenized by stirring for 1 hour.
3) The mixture homogenized in step 2) is stirred at 60˜85° C. for 4˜12 hours, cooled to 30° C. or less, the mixture is filtered, and then the mixture is washed with ethanol and distilled water.
4) The product obtained in step 3) is dried at 105° C.
5) Put it in an electric furnace and heat it at 300° C. for 1 hour, then raise the temperature to 900˜1000° C., heat it up for 4˜6 hours, and cool it to room temperature.
6) Put 100 gr of what was obtained in step 5) in 500 ml of ethanol or water, and adjust the particle size corresponding to 90% of the maximum particle size in the cumulative particle size distribution to 5 μm using a bead mill.
7) The solution obtained in step 6) is spray dried at 150˜300° C. to obtain the compounds of Chemical Formula 1.

The particle size corresponding to 90% of the maximum particle size in the cumulative particle size distribution of the manufactured light emitting body powder was 5 m or less, and as a result of measuring the manufactured light emitting body using a luminescence meter (Photo Luminescence, PSI), excitation by near-infrared rays and near-infrared light emission were shown.

The sample obtained by the above method was excited at 800 nm˜1200 nm with the luminescence meter to confirm that the maximum excitation wavelength was 980 nm, and the luminance of emitting light at the emission wavelength of 1015 nm by irradiating 980 nm was 2.12×10⁴.

### <Embodiment 2>Preparation of Lanthanum Prolide-Silica Compounds and Compounds Consisting of Erbium, Ytterbium, and Zinc

1) Each of the raw materials used in Table 1 is mixed using a bead mill according to the weight ratio to homogenize the raw materials, and the solid content is extracted and dried.

TABLE 2

| Material Name | Molecular Weight | Embodiment 2-1 | Embodiment 2-2 | Embodiment 2-3 |
|---|---|---|---|---|
| LaF₃ | 195.90 | 65.0 w % | 65.0 w % | 65.0 w % |
| SiO₂ | 60.08 | 31.0 w % | — | — |
| Al₂O₃ | 101.96 | — | 31.0 w % | 31.0 w % |
| Er₂O₃ | 382.56 | 1.0 w % | 1.0 w % | 1.0 w % |
| Yb₂O₃ | 394.08 | 2.3 w % | 3.0 w % | 2.3 w % |
| ZnO | 81.38 | 0.7 w % | — | 0.7 w % |

2) Put the homogenized powder of step 1) into an electric furnace, heat it at 800° C. for 1˜4 hours, then raise the temperature to 1100° C., heat it up for 1˜6 hours, and cool it to room temperature.
3) In 250 ml of ethanol or water, 50 gr of the obtained in step 2) is added and the particle size corresponding to 90% of the maximum particle size in the cumulative particle size distribution is adjusted to the level of 5 μm using a bead mill.
4) The solution obtained in step 3) is spray-dried at 150˜300° C. to obtain the compounds of Chemical Formula 2.

The particle size corresponding to 90% of the maximum particle size in the cumulative particle size distribution of the manufactured light emitting body powder was 5 m or less, and as a result of measuring the manufactured light emitting body using a luminescence meter (Photo Luminescence, PSI), excitation by near-infrared rays and near-infrared light emission were shown.

The sample obtained by the above method was excited at 800˜1200 nm with the luminescence meter to confirm that the maximum excitation wavelength was 980 nm, and the luminance of emitting light at an emission wavelength of 1530 nm by irradiating 980 nm is described in Table 3.

TABLE 3

| Classification | Embodiment 2-1 | Embodiment 2-2 | Embodiment 2-3 |
|---|---|---|---|
| Luminescence intensity | 1.42 × 10⁴ | 1.21 × 10³ | 2.55 × 10³ |
| (1530 nm) | | | |

In Embodiment 2-1, it was possible to obtain an infrared-excited infrared light emitting body having remarkably high emission intensity even with small particles through particle size control. The light emitting body manufactured through the preparation method according to the present invention is excited by near-infrared rays, and is characterized in that it emits light in near-infrared rays and does not emit light in visible light, and since the color of the light emitting body itself is white, the light emitting body may be used for items requiring security, such as ink composition, printed matter, sheets, films, yarns, and containers.

### Application Example 1

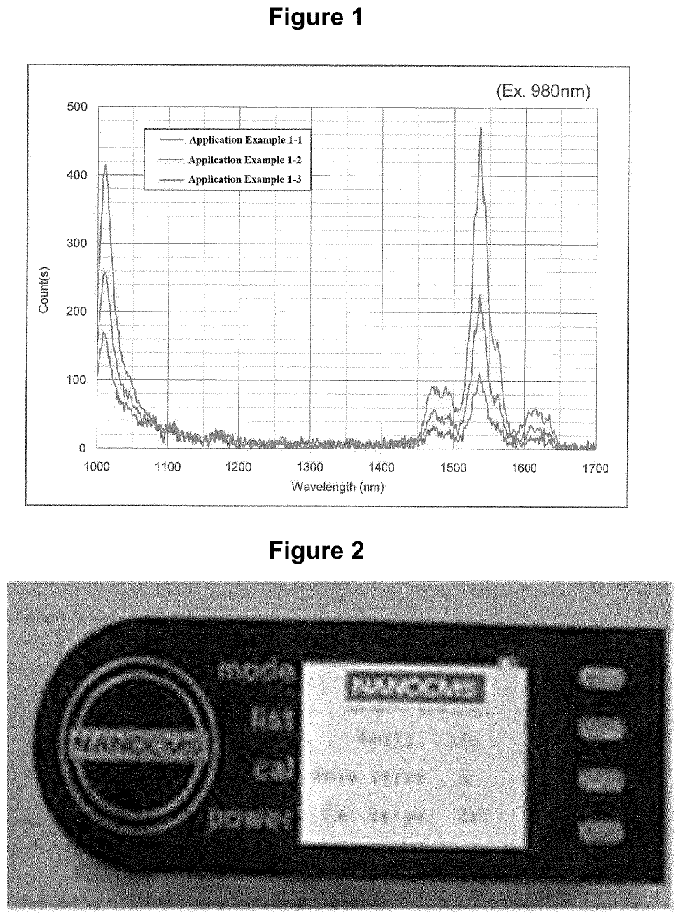

In order to review the applicability of the composition of the security ink, the compounds of Embodiment 1, the compounds of Embodiment 2-1, and the rosinmodified phenolic resin varnish (DV-130, manufactured by Dongyang Ink) were used as the composition shown in Table 4 below. The ink mixed and pulverized in the Hoover Mill was colored with an ink color machine, and the fluorescence intensity was measured with PL equipment (PSI, Inc.), and the results are shown in FIG. 1.

TABLE 4

| | Application Example | Application Example | Application Example |
|---|---|---|---|
| Composition | 1-1 | 1-2 | 1-3 |
| Embodiment 1 | 2.5 w % | 5.0 w % | 10.0 w % |
| Embodiment 2-1 | 5.0 w % | 10.0 w % | 20.0 w % |
| Rosin-modified | 92.5 w % | 85.0 w % | 70.0 w % |
| phenolic resin | | | |
| Total | 100.0 w % | 100.0 w % | 100.0 w % |

### Application Example 2

In order to review the applicability of the film and sheet for security, the compounds of Embodiment 1 and the compounds of Embodiment 2-1 are each mixed in a weight ratio of 1:2 in a polycarbonate compound in 0.1 w %, followed by an extruder at 320° C. was used to obtain a 100 μm film. The results obtained by analyzing the emission intensity at the excitation wavelength of 980 nm and the emission wavelengths of 1015 nm and 1530 nm were 900˜970 and 980˜1030, respectively, using a 320° C. hot plate to obtain a thick sheet by stacking 10 sheets of film as a sample (The detector was developed and applied by Nano CMS, refer to FIG. 2).

### Application Example 3

In order to review the applicability to the yarn for security, the compounds of Embodiment 1 and the compounds of Embodiment 2-1 are each mixed in a weight ratio of 1:2 with 2 w % of polyester resin to make a master batch, and this was mixed with 10 w % of polyester to obtain a security yarn having a thickness of 3 denier/45 filaments. Using the fabric manufactured by weaving this yarn as a sample, the results obtained by analyzing the emission intensity at the emission wavelengths of 1015 nm and 1530 nm at the excitation wavelength of 980 nm were 840˜900 and 910˜940, respectively (The detector was developed and applied by Nano CMS, refer to FIG. 2).

Meanwhile, the above detailed description should not be construed as restrictive in all aspects and should be considered as exemplary. The scope of the present invention should be determined by a reasonable interpretation of the appended claims, and all modifications within the equivalent scope of the present invention are included in the scope of the present invention.

1. A white to pale colored infrared-excited infrared light emitting material that have characteristics such that it is excited when it receives a light with a wavelength in the range of 800˜1000 nm, which is an infrared region, the excited energy induces light emitting in the range of 1000˜1700 nm, which is an infrared region, but does not emit light in the wavelength range of 380˜780 nm, which is a visible region.

2. The infrared-excited infrared light emitting material according to claim 1, characterized in that the luminescent material is a single light emitting body selected from compounds represented by Chemical Formula 1 or Chemical Formula 2 below alone or a mixture thereof, wherein: [symbol]
Chemical Formula 1 [symbol]
YVO₄:Ybₓ
here, 0<x≤1; and [symbol]
Chemical Formula 2 [symbol]
LaF₃—SiO₂:ErₓYb_{y}M_{z}
here, M is Zn, Mg, and Ce, and 0<x≤1, 0<y≤1, 0<z≤1.

3. A preparation method for an infrared-excited infrared light emitting material characterized by comprising the steps of:
a) mixing at least one of lanthanide metal oxides or metal salts selected from the group consisting of compounds containing lanthanum salts, silica salts, erbium salts and ytterbium salts or compounds containing lanthanum fluoride, silicon dioxide, ytterbium oxide and erbium oxide, and zinc, magnesium and cesium;
b) heat-treating the mixture obtained in step a) to prepare a luminescent powder of Chemical Formula 2; and
c) controlling the particle size of the luminescent powder,
wherein [symbol]
Chemical Formula 2 [symbol]
LaF₃—SiO₂:ErₓYb_{y}M_{z}
here, M is Zn, Mg, and Ce, and 0<x≤1, 0<y≤1, 0<z≤1.

4. The white to pale colored infrared-excited infrared light emitting material according to claim 1, wherein the luminescent material has a particle size of 0.01˜50 μm, which corresponds to 90% of the maximum particle size in the cumulative particle size distribution.

5. An ink composition for anti-counterfeit including an infrared-excited infrared light emitting material having an external color of white to pale color and emitting infrared light when excited by infrared light, and emitting one or two infrared wavelengths at the same infrared excitation wavelength, but not emitting light in the visible region.

6. The ink composition for anti-counterfeit according to claim 5, having characteristics in that the infrared-excited infrared light emitting material that has an external color of white to pale color and emits infrared light when excited by infrared light has characteristics such that it is either alone or a mixture selected from Chemical Formula 1 or Chemical Formula 2, and visually appears to be white to colored, and excited by infrared ray when it receives a light with a wavelength in the range of 800˜1000 nm, which is an infrared region, the excited energy induces light emitting in the range of 1000˜1700 nm, which is an infrared region, but does not emit light in the wavelength range of 380˜780 nm, which is a visible region,
wherein: [symbol]
Chemical Formula 1 [symbol]
YVO₄:Ybₓ
here, 0<x≤1, and [symbol]
Chemical Formula 2 [symbol]
LaF₃—SiO₂:ErₓYb_{y}M_{z}
here, M is Zn, Mg, and Ce, and 0<x≤1, 0<y≤1, 0<z≤1.

7. The ink composition for anti-counterfeit according to claim 5, wherein the ink composition is characterized in that it is one selected from the group consisting of screen printing, lithographic printing, gravure printing, intaglio printing, letterpress printing, flexographic printing, and inkjet ink.

8. An article for anti-counterfeit including an infrared-excited infrared light emitting material having an external color of white to pale emitting infrared light when excited by infrared light, emitting one or two infrared wavelengths at the same infrared excitation wavelength, but not emitting light in the visible region.

9. The article for anti-counterfeit according to claim 8, wherein the infrared-excited infrared light emitting material having an external color of white to pale emitting infrared light when excited by infrared light has characteristics such that it is selected from Chemical Formula 1 or Chemical Formula 2 alone or a mixture thereof, and visually appears to be white or colored, and it is excited when it receives a light with a wavelength in the range of 800˜1000 nm, which is an infrared region, the excited energy induces light emitting in the range of 1000˜1700 nm, which is an infrared region, but does not emit light in the wavelength range of 380˜780 nm, which is a visible region, wherein: [symbol]
Chemical Formula 1 [symbol]
YVO₄:Ybₓ
here, 0<x≤1, and [symbol]
Chemical Formula 2 [symbol]
LaF₃—SiO₂:ErₓYb_{y}M_{z}
here, M is Zn, Mg, and Ce, and 0<x≤1, 0<y≤1, 0<z≤1.

10. The article for anti-counterfeit according to claim 8, characterized in that the article is a printed material, a sheet, a film, a yarn or a container.

11. The article for anti-counterfeit according to claim 10, characterized in that the material of the printed material, sheet, and film is one selected from paper material, fiber material and plastic material, wherein the material of the yarn and the container are characterized in that it is one selected from polyester resin, polyethylene resin, polypropylene resin, polycarbonate resin, polyvinyl chloride, polyamide resin, polyurethane, and polyethylene terephthalate (PET).

12. The article for anti-counterfeit according to claim 8, characterized in that it contains 0.01˜50 w % of the infrared-excited infrared light emitting material.

13. The article for anti-counterfeit according to claim 9, characterized in that the article is selected from the infrared-excited infrared light emitting material of Chemical Formula 1 or Chemical Formula 2, alone or a mixture thereof is completely or partially distributed.
